(19) United States
(12) Patent Application Publication
(10) Pub. No.: US 2016/0286847 A1
(43) Pub. Date: Oct. 6, 2016

(54) FROZEN FOOD THAWING

(71) Applicant: NOVASYST INC., Québec, QC (CA)

(72) Inventors: André VILLEMAIRE, Québec (CA); Alexandre VALLIÈRES, Québec (CA); Jean-Thomas LANDRY, Québec (CA)

(21) Appl. No.: 15/034,198

(22) PCT Filed: Nov. 6, 2014
(86) PCT No.: PCT/IB2014/065854

§ 371 Date: May 4, 2016

Related U.S. Application Data
(60) Provisional application No. 61/902,144, filed on Nov. 8, 2013.

(51) Int. Cl. A23L 3/36

(52) U.S. Cl. CPC A23L 3/364; A23V 2002/00

(57) ABSTRACT

A method for thawing frozen food provided in a thawing appliance, the thawing appliance having a membrane forming a barrier between the frozen food and a fluid, the fluid at least partly surrounding the frozen food in use to transfer heat from the fluid to a corresponding surface area of the frozen food, the method including: controlling the fluid 5 at a thawing temperature; monitoring a state of the thawing of the frozen food and generating a state indicator; and controlling the fluid at a conservation temperature when the state indicator indicates a thawing completion state.

### TECHNICAL FIELD

This application relates to the field of food defrosting and more particularly to improved methods and systems for the safe and rapid thawing of frozen food items.

### BACKGROUND OF THE ART

Domestic freezers are convenient appliances for preserving food over extended periods of time. The main disadvantage with this method of conservation of food items is the need to thaw the item before consumption. Typically, a frozen food item is brought from freezer temperatures (approximately −18° C.) to refrigerator temperatures (approximately 4° C.) prior to cooking or warming up the item for consumption.

The thawing process itself has two main inconveniences: long thawing delays and/or the possibility of spoilage during thawing. Food safety organizations recommend that frozen foods be thawed in the refrigerator to prevent the formation of germs, bacteria and pathogens. However this thawing method is extremely long, e.g. several days for a block of meat of 450 grams. This delay requires that people decide on the food item(s) required for the upcoming meal a long time in advance, which is not always practical.

Existing alternative methods include microwave thawing. This method consists in exposing the frozen food item to low levels of microwave radiation. Unfortunately, microwaves are absorbed more strongly by liquid water than by ice leading to localized “run-away” heating in food items. Food items thawed using the microwave method usually exhibit uneven results with sections visibly denatured or even partially “boiled”. This is especially true for irregularly shaped food items.

Another method used to thaw frozen food is to leave the items outside of the freezer or refrigerator at ambient conditions, for example on a kitchen counter. Unfortunately, this method is also very slow, requiring several hours to warm a frozen block of meat of 450 grams from −20° C. to 0° C. If the item is left at ambient temperatures for a long period, bacteria and other forms of spoilage can develop in the food item. Consequently food safety organizations strongly disapprove of this method.

Also, if the food item stays at room temperature for extended periods of time, some denaturation and discoloration may occur. This affects the appearance of the food item and may also affect its taste.

### SUMMARY

Methods and systems for the rapid thawing of frozen food items are disclosed herein.

According to one broad aspect of the present invention, there is provided a method for thawing frozen food provided in a thawing appliance, the method including: controlling the fluid at a thawing temperature; monitoring a state of the thawing of the frozen food and generating a state indicator; and controlling the fluid at a conservation temperature when the state indicator indicates a thawing completion state.

In one embodiment, the thawing appliance has a membrane forming a barrier between the frozen food and a fluid, the fluid at least partly surrounding the frozen food in use to transfer heat from the fluid to a corresponding surface area of the frozen food.

In one embodiment, the method further comprises displacing the fluid along a thawing path in the thawing appliance, the fluid being displaced from an inlet to an outlet of the thawing path.

In one embodiment, monitoring the state of the frozen food includes at least one of measuring the frozen food mass, measuring the frozen food volume, monitoring a texture of a surface area of the frozen food, measuring a heat transferred to the frozen food and measuring a surface temperature of the frozen food.

In one embodiment, monitoring the state of the thawing includes calculating an injected heat value using an output temperature, the thawing temperature and a rate of displacement of the fluid in the thawing appliance, the output temperature being a temperature of the fluid measured at the outlet of the path.

In one embodiment, the method further comprises detecting an occurrence of a phase-change plateau using the injected heat value; calculating a time Tₚ required to reach the plateau; and correlating the time Tₚ with a thawing duration, wherein the generating the thawing completion state indicator being carried up after the thawing duration has elapsed.

In one embodiment, the method further comprises calculating an approximate surface temperature of the frozen food using the injected heat value.

In one embodiment, the membrane is composed of adjacent walls of a plurality of bladders containing the fluid.

In one embodiment, the membrane is composed of adjacent walls of a plurality of bladders containing the fluid and wherein the bladders include passageways to force the fluid to follow the thawing path during the displacing.

In one embodiment, the method further comprises receiving a thawing process trigger, the thawing process trigger being caused by at least one of detection of an opening of the thawing appliance, detection of an insertion of the frozen food in the thawing appliance, detection of a closing of the thawing appliance, receipt of a user input to trigger the thawing process.

In one embodiment, the thawing temperature is 12 degrees Celcius.

In one embodiment, the conservation temperature is 4 degrees Celcius.

In one embodiment, the food item is surrounded by a food containment bag.

In one embodiment, the method further comprises bringing the fluid close to a surface of the frozen food by at least one of collapsing the membrane onto the frozen food by applied a vacuum between the frozen food and the membrane, modifying a pressure of an interior of the thawing appliance and modifying a pressure of the fluid in the thawing appliance.

In one embodiment, the method further comprises outputting a user notification, the user notification including at least one of information about the state of the frozen food, information about a time remaining to reach the thawing completion state and information about the state of the thawing.

In one embodiment, the fluid is water.

In one embodiment, the controlling the fluid at the thawing temperature includes compensating for a heat transfer loss caused by the membrane.

In one embodiment, the thawing temperature is comprised between 8 and 20 degrees Celcius.

In one embodiment, the conservation temperature is comprised between 0 and 10 degrees Celcius.

In one embodiment, the controlling the fluid at the conservation temperature includes controlling the fluid at at least one intermediary temperature between the thawing temperature and the conservation temperature.

### BRIEF DESCRIPTION OF THE DRAWINGS

Having thus generally described the nature of the described systems and methods, reference will now be made to the accompanying drawings, showing by way of illustration example embodiments thereof.

FIG. 1 includes FIG. 1A and FIG. 1B in which FIG. 1A is a cutout side view of a frozen food item next to an example thawing appliance and FIG. 1B is a cutout side view of the frozen food item inserted in the example thawing appliance;

FIG. 2 is a perspective view of an example thawing appliance installed in the door of a domestic refrigerator;

FIG. 3 is a perspective view of the example thawing appliance of FIG. 2 with its door open;

FIG. 4 is a fluid circulation diagram for an example embodiment;

FIG. 5 is a flow chart of example main steps of an example thawing method;

FIG. 6 is a block diagram of an example thawing system showing system control aspects;

FIG. 7 is a block diagram of an example thawing system;

FIG. 8 is a time diagram of an example thawing cycle;

FIG. 9 includes FIG. 9A and FIG. 9B in which FIG. 9A is a cutout side view of a frozen food item in an example thawing appliance and FIG. 9B is a cutout side view of the frozen food item in the example thawing appliance when a vacuum is applied;

FIG. 10 is a perspective transparent view of a frozen food item showing the position of temperature sensors for an experiment;

FIG. 11 is a graphic showing the temperature of two locations inside the mass of meat illustrated in FIG. 10 as a function of time during the thawing process inside an example thawing appliance; and

FIG. 12 is a graphic showing the temperature of two locations inside the mass of meat illustrated in FIG. 10 as a function of time during the thawing process inside a refrigerator.

It will be noted that throughout the appended drawings, like features are identified by like reference numerals.

### DETAILED DESCRIPTION

The present disclosure presents systems and methods for thawing frozen food items.

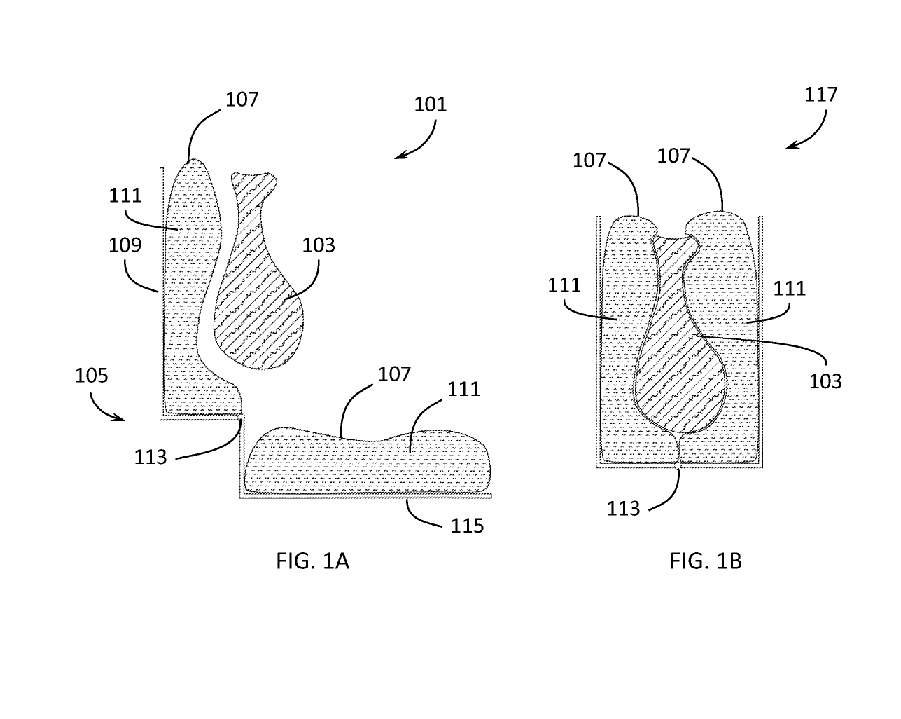

FIG. 1A and 1B illustrate a method for rapidly thawing frozen food while minimizing the risk of pathogens, germs and bacteria growth. As shown in FIG. 1A, a frozen food item 103 is brought in close proximity to a thawing appliance 105 in an open configuration 101 composed of bladders 107 housed in a rigid enclosure 109. In one embodiment, the bladders 107 are made of supple, elastic and leak-proof membranes containing a heat transfer fluid 111.

The example thawing appliance 105 is articulated using a hinge 113 allowing the pivoting of the bottom half of the enclosure 115 in such a manner for the frozen food item 103 to come in physical contact with the bladders 107 in the closed configuration 117, as illustrated in FIG. 1B. Upon closing of the enclosure 109, the frozen food item 103 can be nearly completely surrounded by the bladders.

In one embodiment, the bladder membranes are chosen to feature a high heat conductivity coefficient, thus maximizing the heat exchange between the heat transfer fluid 111 and the frozen food item 103.

The heat transfer fluid 111 can be composed of water. It can be composed of aqueous solutions including various fungicidal, algaecidal and anti-microbial additives to prevent biological growth that could degrade the performance of the appliance. Other types of fluids less susceptible to algae and biological growth such as ethylene glycol and inorganic liquids can also be used.

The frozen food item can be wrapped in a waterproof bag. For example, meat items are often vacuum-sealed in plastic bags to prevent so-called “freezer burns”. These are referred to herein as food containment bags. During the thawing process, these bags offer a convenient containment of the food item and the liquids released by the item upon thawing. These bags also provide a barrier to prevent soiling the thawing apparatus, thus easing maintenance and cleaning.

In one embodiment, a liquid sensor is present in the appliance in order to detect the presence of thawing fluid coming out of the frozen item bag. This event can trigger a warning to the user to clean the appliance thus avoiding microbial contamination.

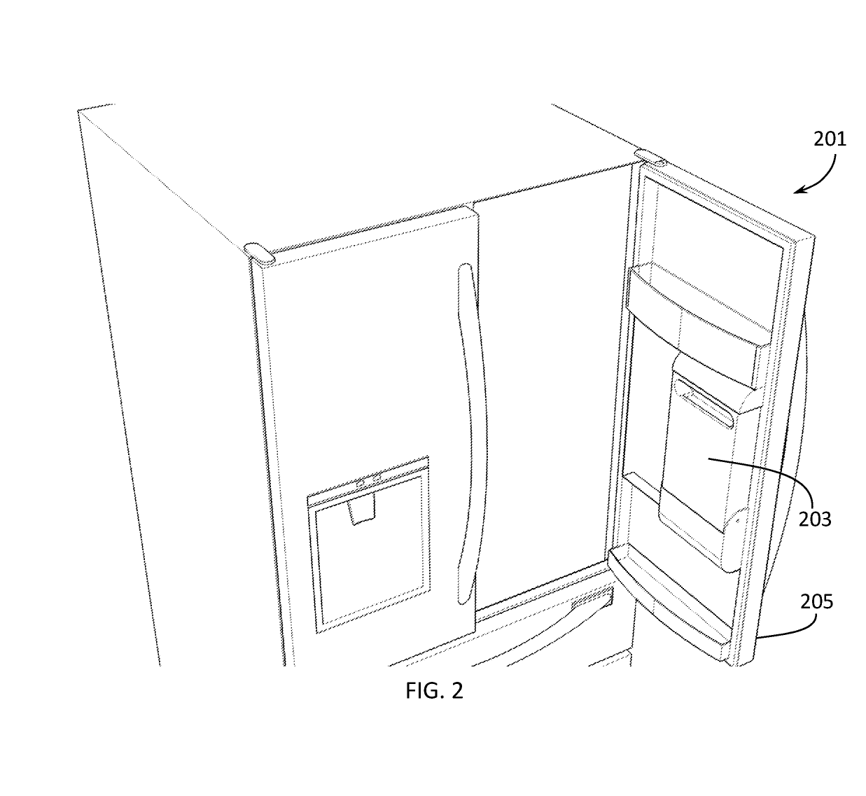

FIG. 2 shows an example thawing appliance 203 implemented vertically in the door 205 of a refrigerator 201. The presented bladder-assisted thawing system can also be implemented horizontally. A horizontal geometry can be implemented in a refrigerator using a “drawer” configuration employing mechanical sliding mechanisms to save space and allow stacking of several units in a compact fashion.

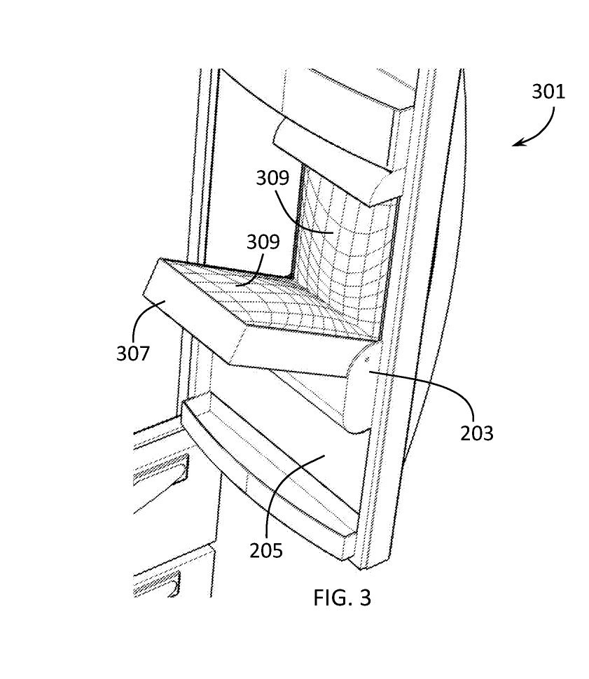

FIG. 3 illustrates the thawing appliance 203 shown in FIG. 2, installed in a refrigerator 301 with the appliance door 307 open and revealing two internal bladders 309.

A hinged two-part appliance as represented in FIG. 3 eases the cleaning of the device after use. When open, the appliance reveals two surfaces that can be wiped clean with a sponge or cloth. The hinge mechanism can also be designed so that upon complete opening the appliance, a gap between the bladders is created to allow reaching deep into the hinge area for thorough cleaning.

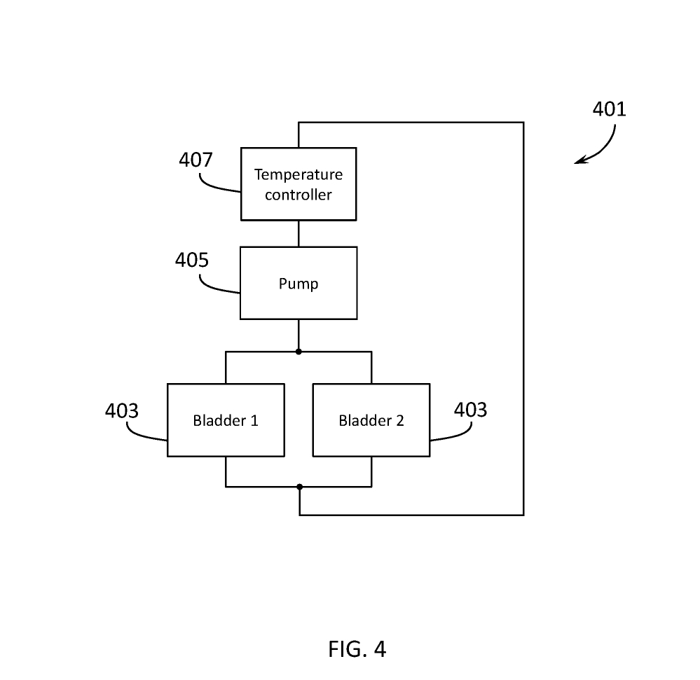

FIG. 4 shows a fluid circulation diagram 401 for an example embodiment. In this example, the heat transfer fluid is forced to circulate in the bladders 403 using a fluid pump 405. Upon return from the bladders 403, the fluid enters a temperature controller 407 where the fluid temperature is raised or lowered in order to attain the desired temperature. In the example shown in FIG. 4, the bladders 403 are connected in parallel but other arrangements, e.g. in series, are also possible. Fluid circulation with temperature control allows the thawing process to be performed at a specific temperature.

In one embodiment, the heat transfer fluid has a high heat capacity thus limiting the temperature decrease of the fluid upon heat transfer to the frozen food item. This allows decreasing the flow of fluid while preserving a nearly constant thawing temperature. Phase change materials including paraffin and salt hydrates can be added to the heat transfer fluid as a mean to increase its heat capacity.

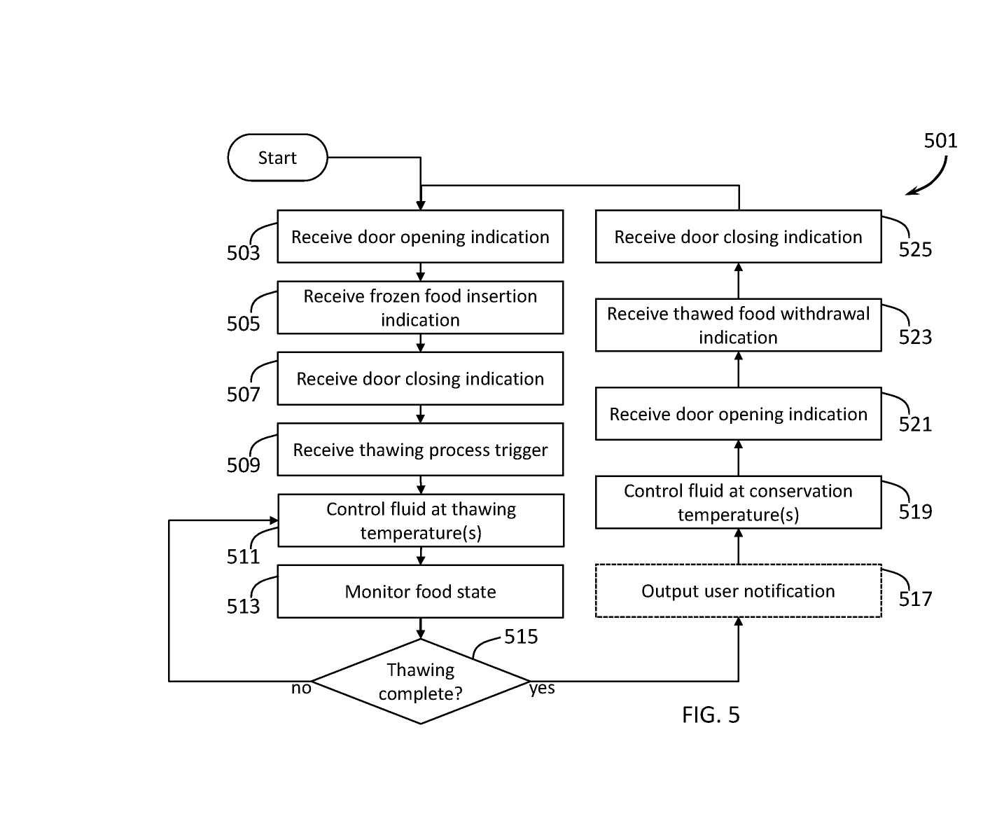

FIG. 5 shows a flow chart 501 of example main steps of a thawing method. The cycle starts when the appliance receives an indication that the appliance access door has been opened 503. This information can be obtained from limit switches, proximity sensors or a number of other appropriate door sensors.

The appliance can also be configured to sense the insertion of the frozen food item 505. One such method involves a weight sensor embedded in the appliance to measure the presence of a frozen food item. Another method involves measuring the volume of the frozen food item, which can be accomplished using a variety of methods.

The appliance can receive an indication that the appliance access door has been closed 507 in a similar way to when it is opened 503.

At this point when the frozen food is in the thawing appliance, the appliance can receive a signal 509 to initiate the thawing cycle for example from a start button located in the user interface. Alternatively, the closing indication 507 of the appliance door can also serve as a trigger for starting the thawing cycle.

After the start of the thawing cycle, the appliance control circuits take the appropriate actions in order to control the temperature 511 of the appliance fluid to the desired thawing temperature. The fluid can circulate in a closed-circuit way or can be provided into the system and discarded after use.

In meat products, calpains (calcium proteins) begin to denature and lose activity at a temperature of approximately 40° C., but subtle changes in food color, texture and taste can occur at lower temperatures. At higher temperatures, other proteins such as myosin (motor protein) and red myoglobin (iron/oxygen binding protein) are altered leading to severe alteration of color and texture. Typical thawing temperatures are between 8° C. and 20° C., depending on the nature of the food item. The upper bound is chosen to prevent alteration of the food items during thawing. The lower bound is chosen to shorten the thawing process as much as possible.

The state of the food item can be monitored 513 in order to determine the end of the thawing cycle. Several methods can be used to monitor the state of the food item. In one embodiment, the heat transferred to the frozen food is monitored by measuring the fluid temperature difference at the input and at the output of the bladders. This information, in addition to the flow rate of the liquid (obtained by measurement or by characterization), allows calculating the amount of heat transferred to the food item at all times. As detailed furtherherein, the rate of change of the transferred heat per unit time can indicate the presence of a phase-change plateau. The phase-change plateau signals that the water contained in the food item approaches a phase change from ice to liquid. The time required to reach this plateau is indicative of the mass and nature of the food item. This information allows predicting the time when the complete thawing of the food item will be attained based on laboratory tests.

Alternative methods can be used to monitor the state of the food item undergoing the thawing cycle. These include the calculation of the expected thawing time based on the mass of the food item. The mass of the food item can be measured in the appliance using, for example, a load cell or other appropriate sensors. Alternatively, it can be provided by a user through a user interface using numerical keys.

Alternatively, the calculation of the expected thawing time can be based on the volume of the food item. The volume of the food item can be determined in the appliance by measuring the displacement of a fluid (Archimedes' principle), by using 3D sensors viewing the food item while approaching the appliance or by using other volumetric methods. Again, the expected time to defrost can be calculated based on laboratory tests on standard frozen food items of known volumes.

A more direct method of monitoring the state of the item is to perform a contact temperature measurement of the food item using a surface thermometer. As explained furtherherein, the surface temperature and its variation in time is indicative of the state of the interior of the food item.

Alternatively a measurement of the resilience of the food surface can be used to detect a softening of the food and to identify the upcoming phase change. A resilience sensor can be fabricated using a mechanical probe equipped with a sensor that measures pressure as a function of a displacement caused by an actuator.

Information about the calculated amount of thawing time left or the actual food temperature can be displayed on a user interface. The thawing unit can have its own dedicated display or the information can be sent to a refrigerator central user interface for display.

In yet another embodiment, the thawing cycle is determined by a standard time interval or by a time entered at the user interface.

Once the end of the thawing cycle has been detected 515, the appliance can optionally notify the user 517 using an audible chime, an illuminated light-emitting-diode (LED), a message on the user interface, a SMS, an email, a message on a personal portable device or any other suitable means.

When the end of the thawing cycle has been detected, the appliance can also bring the temperature of the appliance fluid to a conservation temperature 519. The conservation temperature can be a temperature close to refrigerator temperatures, e.g. 2 to 4° C., which are considered safe to store food products such as meat and vegetables for extended periods of time. The conservation temperature has to be above 0° C. to prevent re-freezing and below 10° C. to prevent the growth of bacteria, germs and pathogens.

The thawing appliance can then receive an indication that the appliance access door has been opened 521, the food item has been withdrawn from the appliance 523 and/or that the appliance access door has been closed 525. The appliance is then ready for another thawing cycle.

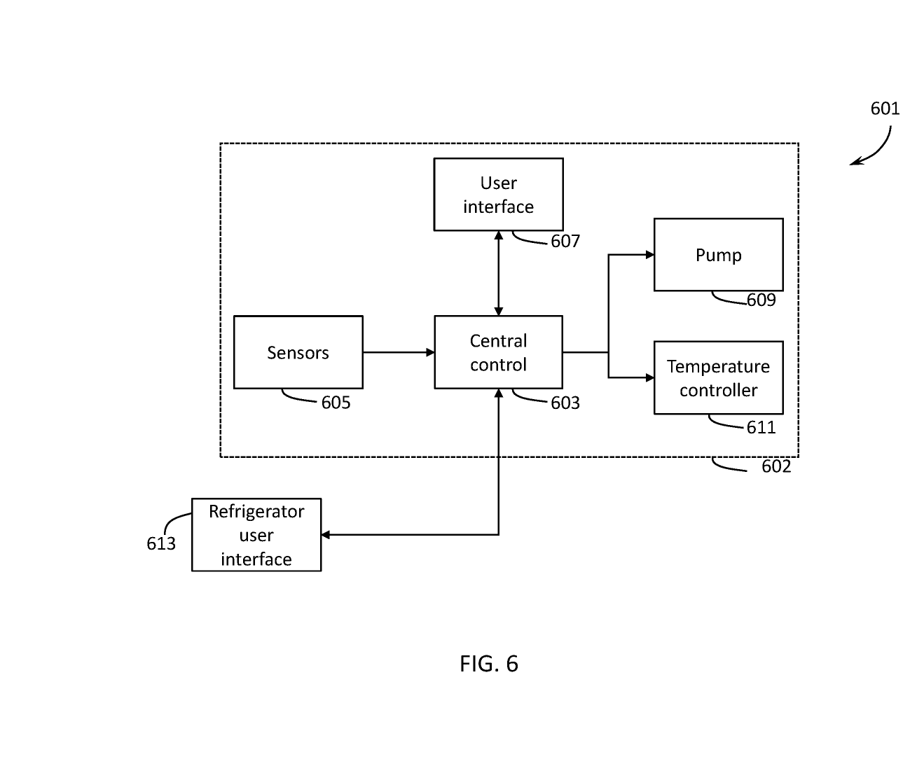

FIG. 6 shows a block diagram 601 of an example thawing system 602 showing system control aspects. A central control unit 603 can receive signals from several types of sensors 605, including temperature sensors, flow rate sensors, weight sensors, pressure sensors, limit switches, proximity switches, etc. The central control unit 603 can also receive information coming from the user interface 607 in the form of a start signal and information about the frozen food item.

Based on the information received, the central control unit 603 can command a thawing liquid circulation pump 609 and optionally a temperature controller 611 in order to execute the thawing cycle.

At several points in the thawing cycle, the central control unit 603 can provide information and notifications to the user interface 607. In addition to an end-of-cycle notification, information about the amount of thawing time left or the actual food temperature can also be displayed. The thawing system 602 can have its dedicated display or the central control unit 603 can send the information to the central refrigerator user interface 613 for display. The thawing system 602 can also be designed to interface with remote controls and mobile smart phones using wireless or wired links.

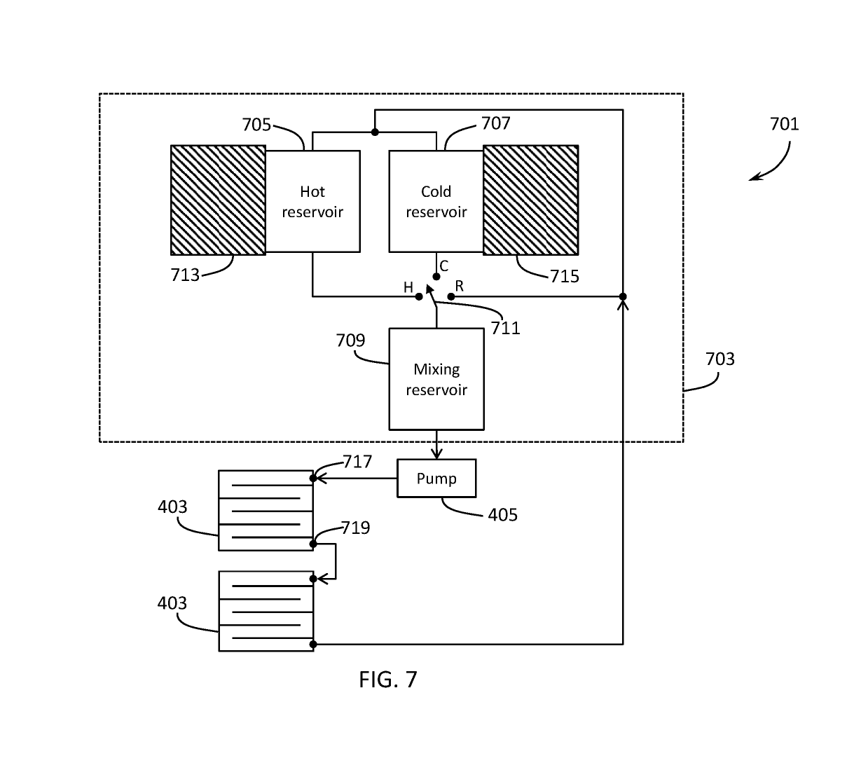

FIG. 7 shows a block diagram of an example embodiment. The thawing appliance 701 uses a temperature controller 703 composed of three reservoirs 705, 707, 709 and a three-way valve 711. Based on the phase of the thawing cycle, the central control unit commands a certain setpoint temperature, e.g. the thawing temperature or the conservation temperature. In the example shown in FIG. 7, the control of the fluid temperature is achieved by controlling the position of the three-way valve 711 based on the temperature of the fluid in the mixing reservoir 709 and the desired setpoint.

In this example, the heat transfer fluid is circulated in two bladders 403 in series using a pump 405 and a closed circuit. Open circuit configurations can also be implemented if there is access to a drain for the exhaust fluid.

The hot reservoir 705 can contain fluid at a temperature slightly above the desired setpoint temperature. The cold reservoir 707 can contain fluid at a temperature slightly below the desired setpoint temperature. By selecting the hot reservoir 705 or the cold reservoir 707 according to a temperature control algorithm, the temperature of the fluid in the mixing reservoir 709 is raised or lowered, respectively.

One method to maintain the hot reservoir 705 above the desired setpoint temperature is to place the hot reservoir 705 in physical contact with a heat sink 713 at a temperature above the desired setpoint. For example if the thawing appliance 701 is mounted on a refrigerator door, the hot reservoir 705 can be located inside the refrigerator door in close proximity with the outside surface of the refrigerator door, which is normally close to ambient temperatures 22-28° C.

Similarly one method to maintain the cold reservoir 707 below the desired setpoint temperature is to place the cold reservoir 707 in physical contact with a heat sink 715 at a temperature below the desired setpoint. For example if the thawing appliance 701 is mounted on a refrigerator door, the cold reservoir 707 can be located inside the refrigerator door in close proximity with the inside surface of the refrigerator door, which is normally close to refrigerator temperatures around 4° C.

In the example of FIG. 7, the return of the heat transfer fluid can take three different paths. Nominally, the return of the heat transfer fluid uses path (R) as selected by the three-way valve 711 which is commandable. If the three-way valve 711 is set to position H, the return path forces some of the fluid from the hot reservoir 705 to enter the circuit, thereby elevating the temperature of the fluid. Conversely if the three-way valve 711 is set to position C, the return path forces some of the fluid from the cold reservoir 707 to enter the circuit, thereby lowering the temperature of the fluid. This effect can be gradual if a mixing reservoir 709 is used as shown in FIG. 7.

The presence of the mixing reservoir 709 is optional. A mixing reservoir 709 acts as an electrical capacitor and reduces the rate of temperature change according to its size. It can be used to reduce the switching frequency of the three-way valve 711.

A variant of the approach presented in FIG. 7 is to have the reservoirs constructed using hollow tubes laid out on either side of the refrigerator door insulation. The hot reservoir can be constructed using a tube located between the door insulation and the metal door external surface. The cold reservoir can be constructed using a tube located between the insulation and the door internal surface. These “reservoirs” can be connected to the appliance using the scheme presented in FIG. 7.

Obviously, several other methods can also be utilized to achieve temperature control. One method includes using electric heating elements and cooling coils from a compressor to control the temperature of the fluid. Alternatively, the residual heat from a compressor, including the refrigerator main compressor, can also be used to heat the fluid. Combustion of fuels such as natural gas can also be used to inject heat in the circuit. Similarly a cooling path from the refrigerator main compressor may be used to perform cooling of fluid. An input of municipal water can also be used to perform this task.

Cooling and heating can be applied to reservoirs as shown in FIG. 7 but can also be applied in line to an area of the fluid circuit and avoid using reservoirs. The use of reservoirs instead of in-line input for temperature control allows using less powerful heating and cooling elements because the thermal work can be performed over longer periods of time.

Another possibility is to use a heat pump to thermally condition the hot and cold reservoirs, simply by transferring (pumping) heat from the cold reservoir to the hot reservoir. The heat pump can be a thermo-electric cooler or a conventional gas compressor-type cooler.

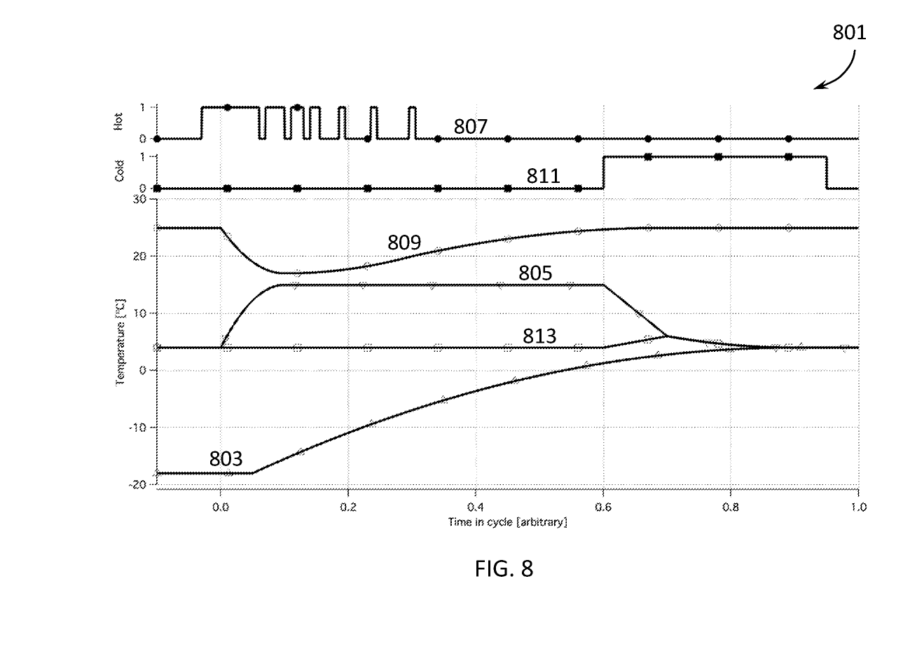

FIG. 8 illustrates an example thawing cycle 801 as a function of cycle time. The objective of the thawing appliance is to safely bring the temperature of the frozen item from the frozen state at −18° C. to above 0° C. as quickly as possible. This is shown using curve 803 with open triangles pointing upwards. At the beginning of the cycle, the temperature of the heat transfer fluid in the mixing reservoir is at normal refrigerator temperature, in this example 4° C. Curve 805 shows the temperature of the heat transfer fluid in the mixing reservoir over time using open triangles pointing downwards.

Upon triggering of the thawing cycle, the three-way valve 711 is set to position H. The commands of the valve over time are shown in binary curve 807 with solid circles in FIG. 8. This connection causes two things, a rapid increase in temperature of the heat transfer fluid in the mixing reservoir (curve 805) and a corresponding decrease of the temperature of the hot reservoir as shown on curve 809 with open circles.

When the temperature of the heat transfer fluid in the mixing reservoir reaches the thawing setpoint, the three-way valve 711 starts to oscillate between position H and position R, in such a way as to keep the temperature of the heat transfer fluid in the mixing reservoir as close as possible to the thawing setpoint. Meanwhile, the temperature of the hot reservoir increases again as it thermalizes with its elevated temperature heat sink.

When the temperature of the frozen item approaches its thawed state, the temperature setpoint is changed to the conservation temperature, e.g. 4° C. The three-way valve 711 switches to position C, in order to cool the heat transfer fluid in the mixing reservoir as fast as possible. This is seen in the binary curve 811 with solid squares. While the three-way valve 711 is at position C, the temperature of the heat transfer fluid in the mixing reservoir decreases and the temperature of the cold reservoir increases as shown on curve 813 with open squares. Eventually, the temperature of the cold reservoir returns to the temperature of the heat sink 715. At the same time the temperature of the heat transfer fluid in the mixing reservoir lowers towards the conservation temperature.

Once the temperature of the heat transfer fluid in the mixing reservoir is back at the final thawing temperature, the three-way valve 711 is set at position R and the thawing appliance has returned to its initial state and is ready for another thawing cycle. The frozen food has been thawed and is ready for consumption, warming up or cooking.

In one embodiment, the monitoring of the temperature of the frozen item (equivalent to curve 803) is obtained using temperature sensors installed on the inside of the bladders, in close proximity with the frozen item. In another embodiment, this temperature can be calculated based on the knowledge of the heat transfer fluid flow, the changes of temperature of the fluid in the reservoirs, the temperature of the hot and cold sinks and/or the knowledge of the position of the three-way valve 711.

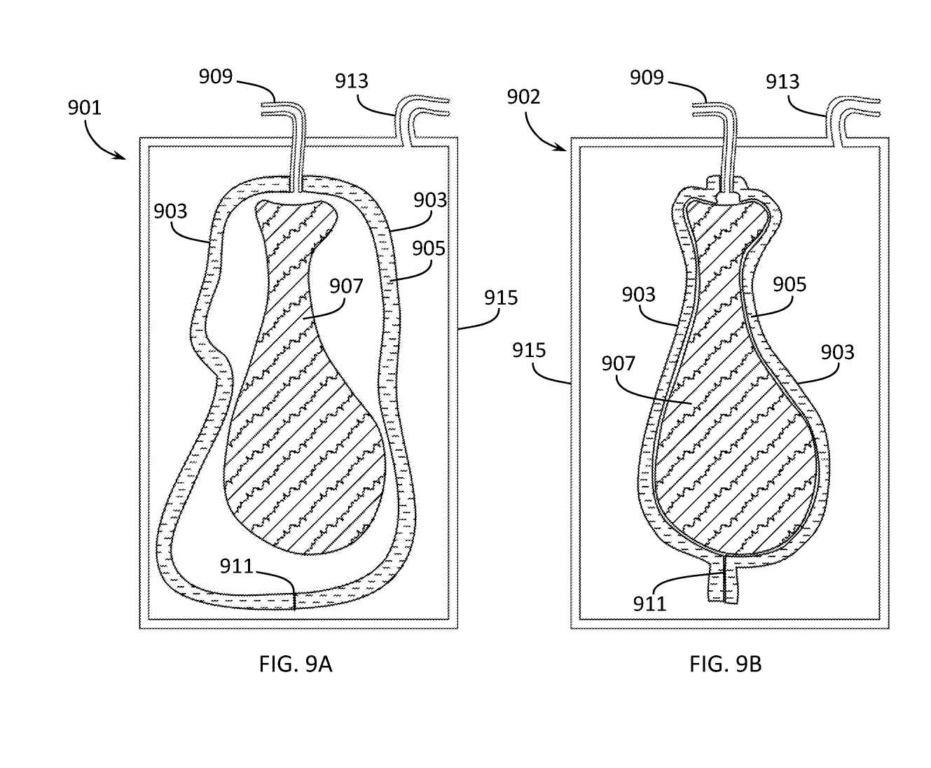

Another example embodiment 901 is presented in FIG. 9A and FIG. 9B. In this example the bladders are designed to be thin and flexible so as to provide a thin but mostly constant thickness of heat transfer fluid 905 across the surface of the frozen food item 907. We refer to this approach as the “heat blanket”. The heat blanket approach minimizes the amount of heat transfer fluid 905 used in the thawing appliance, while still providing high-efficiency heat transfer with the food item. A reduced amount of heat transfer fluid reduces the energy demand to change the fluid temperature during the thawing cycling.

The heat blanket can be composed of a maze of heat transfer fluid passageways as illustrated in FIG. 7. This maze is supplied with heat transfer fluid via an inlet port 717. The fluid circulates through the maze, the thawing path, and exits through the outlet port 719. The heat blanket and the supporting membrane can be made of elastic and durable materials such as natural rubber, latex, PVC or other suitable materials. Food grade material may be used for added safety, although the apparatus does not normally come in contact with the food item, since the food items are usually contained in a freezer bag.

FIG. 9B shows an illustration of an example embodiment 902 of such a heat blanket approach, where a partial vacuum between the frozen food item 907 surface and the inner surface of the heat blanket 903 is established using port 909, referred to as the “vacuum port”. Sealing edges 911 are required in the zones where blankets meet in order to prevent air leaks and for this vacuum approach to function properly. FIG. 9A is an illustration before the vacuum is established. In this state, the substantial amount of air between the frozen food item 907 and the heat blanket 903 prevent efficient heat transfer to take place between the two surfaces.

As shown in FIG. 9B, the vacuum between the frozen food item 907 surface and the inner surface of the heat blanket 903 ensures that a complete and intimate contact is established between these two surfaces, thereby maximizing the heat exchange. One must minimize the presence of gases or air between the heat exchanging surfaces, since the thermal conductivity of gasses is orders of magnitude lower than that of liquids or solids.

There are other ways to improve the thermal performance of the blanket-to-frozen food interface. One approach is to pressurize the appliance enclosure 915 using a fluid, which could be air, another gas or even a liquid. This enclosure 915 can be pressurized using the enclosure port 913 shown in FIG. 9. In this manner the pressure inside the enclosure 915 is transmitted to the heat blankets 903 and in turn to the frozen food item 907. In this case, the “vacuum port” 909 becomes a venting port allowing the interstitial gas to escape.

One advantage of using vacuum instead of pressure is that the complete heat transfer fluid circuit can remain near ambient pressures, thereby minimizing the risk of leaks. Another advantage is to not require a sturdy enclosure capable of sustaining pressure.

In another embodiment, the freezer bags can feature built-in passageways for the circulation of the heat transfer fluid. In this case the bag would need to be connected to inlet and outlet sockets to establish the circuit of the heat transfer fluid. These bags can be cleaned and reused or disposed of after each use.

The membrane material used for the bladder or heat blankets has a finite thermal resistance coefficient and thus causes a temperature decrease along the direction of heat flow. This means that during the initial phase of the thawing when a large heat flow is present, the surface of the bladders or heat blankets are operating at a lower temperature than the desired setpoint, leading to a lengthening of the thawing cycle. If the rate of heat flow is known as described earlier, it is possible to operate with the ideal thawing temperature by compensating for this known temperature gradient. For example if we estimate that 2 J/s (i.e. 2W) heat is flowing from the heat transfer fluid to the frozen food, and that the thermal resistance of the bladder membrane is 0.3 K/W, we conclude that a 0.6K gradient exists between the heat transfer fluid and the frozen food external surface. With this information, the system can directly compensate for this temperature gradient by increasing the temperature of the heat transfer fluid by the calculated temperature gradient, here 0.6K. In this way the thawing process is optimal despite the thermal resistance of the bladder membrane. The same method can be used to compensate for temperature gradients inside the frozen food bag material, if it is known.

Experiment

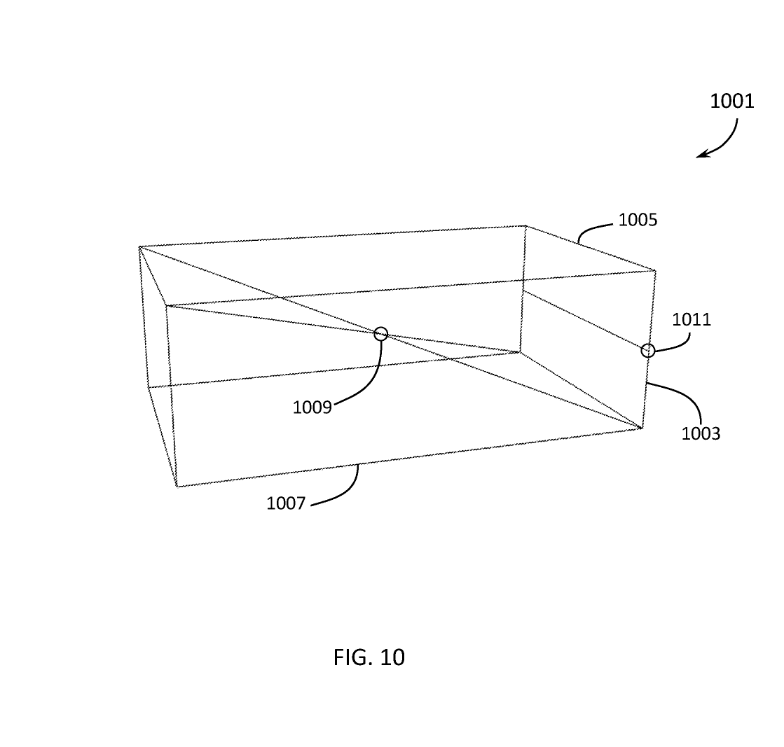

Experimental temperature data was acquired with one embodiment. In this experiment, 450 grams of ground beef was formed into rectangular prisms of edges approximately 5×9×15 cm, respectively edges 1003, 1005 and 1007 in FIG. 10. Two temperature sensors were installed inside each volume of meat. One sensor, referred to as center sensor 1009, is positioned in the geometric center of the rectangular prism 1001 as illustrated in FIG. 10. The other sensor, referred to as edge sensor 1011, is positioned near the middle of edge 1003 of the rectangular prism 1001. The meat masses are placed in vacuum bags for domestic use and the temperature sensor wires are allowed to exit through sealable openings prior to vacuum sealing of each bag.

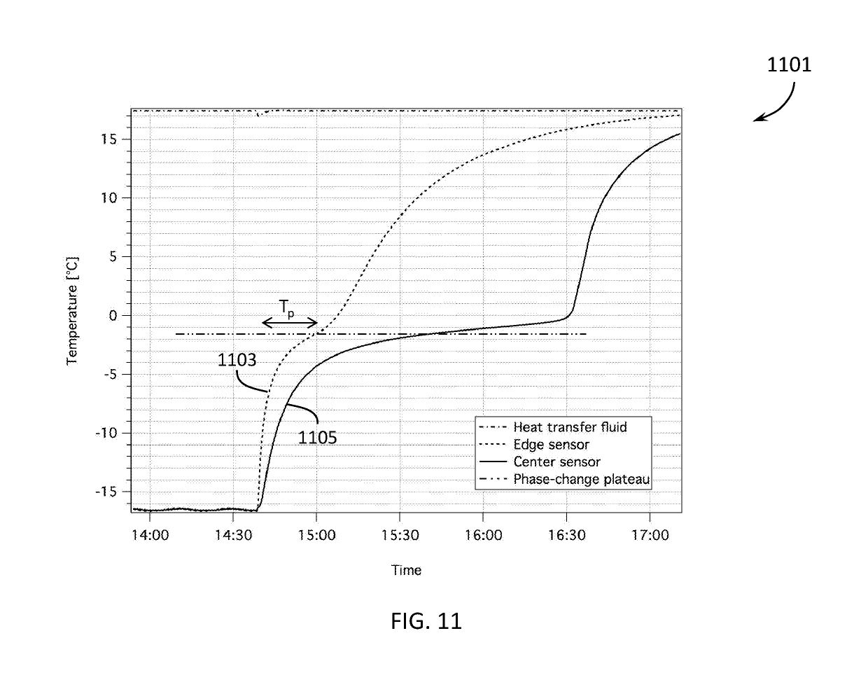

A first block of meat prepared in this manner was frozen to −17° C. The meat was then thawed using the disclosed system and method resulting in curves 1103 (edge sensor) and 1105 (corner sensor) shown in FIG. 11. In this embodiment of the appliance, the thawing temperature of the heat transfer fluid was 17.4° C. As seen in graphic 1101 shown in FIG. 11, the appliance was prevented to command the conservation temperature of 4° C. in order to study the complete thawing of the frozen meat.

As shown in FIG. 11, the thawing cycle performed in the thawing appliance clearly displays a plateau i.e. a slowing of the rate of temperature change, after an initial rapid temperature change. This plateau corresponds to the phase transition of the water contained in the food item, i.e. water going from ice to liquid. The reason why the rate of temperature change is reduced during this period is due to the relatively high latent heat that is required for water to undergo the phase change.

The thawing cycle in the thawing appliance examined in FIG. 11 takes approximately 30 min to 60 min depending on the criterion used for declaring a block of meat to be thawed. For example the edge sensor indicates that 21 min after the beginning of the thawing process, this region of the meat has reached its phase-change plateau. In this state, most of the exterior of the food item is soft and adjacent sections could be separated. After 60 min the center of the meat has reached the middle of its phase-change plateau, a point where the complete item is malleable even if small-scale crystals are still present in the very center of the item.

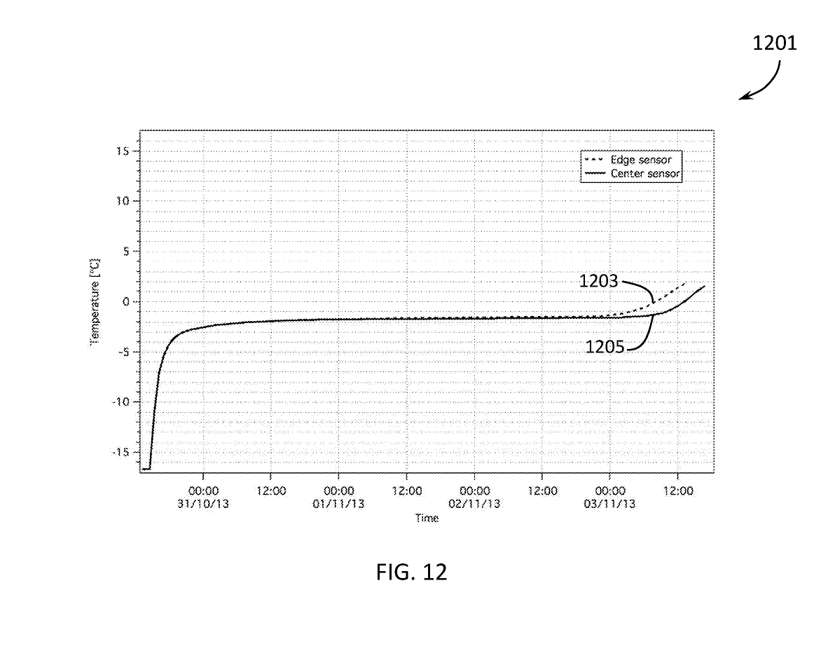

In order to compare the disclosed method with prior art refrigerator thawing, an identical block of meat was frozen to −17° C. and was thawed in a refrigerator environment at 4° C., resulting in curves 1203 (edge sensor) and 1205 (corner sensor) shown in FIG. 12. In this case the phase change plateau is very visible in graphic 1201, shown in FIG. 12 and it extends over more than three days. The reason for this very slow thawing is the low heat transfer efficiency of air (convection) compared to the conduction of the thawing fluid of the disclosed method. The very slow transfer of heat is also evidenced by the very small temperature gradient between the edge sensor 1203 and the corner sensor 1205. The heat flux q is equal to the thermal conductivity k multiplied by the temperature gradient ΔT. Conversely the large gradient seen in FIG. 11 for disclosed method measurements between curves 1103 (edge sensor) and 1105 (corner sensor) indicates that heat flow is quite large, in agreement with the short thawing times.

It is interesting to note that this plateau can act as indicators of the internal state of the food item. Since the temperature difference between the heat transfer fluid and the surface of the food item is directly proportional to the heat being transferred to the food item, monitoring the amount of heat transferred to the food item allows to infer the surface temperature of the food item. Furthermore, by monitoring the surface temperature of the food item over time, one can detect the presence of phase-change plateau as seen in FIG. 11 and thus predict the internal state of the food item. The time Tₚ required to reach the plateau is indicative of the size and mass of the food item. This time Tₚ can be correlated with the time required to completely thaw various food items in laboratory tests. The results from these studies can be compiled in look-up tables that can be implemented in thawing appliances. Consequently, measuring the amount of heat being transferred to the food item allows knowing about the internal state of the food item and allows predicting when the thawing will be completed. This approach enables to automate the thawing process.

In summary, the method for thawing frozen food has three main steps: controlling the fluid at a thawing temperature; monitoring a state of the thawing of the frozen food and generating a state indicator; and controlling the fluid at a conservation temperature when the state indicator indicates a thawing completion state. The conservation temperature is higher than 0° C. and the thawing temperature is greater than the conservation temperature. The frozen food is therefore brought to a high thawing temperature, monitored to detect a change in its state from frozen to at least partly thawed and then brought to a lower conservation temperature to facilitate conservation for an extended period of time. The method is automated to allow the user to place the frozen item in the thawing appliance and forget it for hours/days without a high risk of degradation of the item.

The thawing appliance which allows this thawing method to occur has a membrane forming a barrier between the frozen food and a fluid. The membrane receives the frozen food item. The fluid surrounds the frozen food at least partly in use to transfer heat from the fluid to a corresponding surface area of the frozen food.

In one embodiment, the fluid is displaced along a thawing path in the thawing appliance, the fluid being displaced from an inlet to an outlet of the thawing path.

In order to monitor the state of the frozen food, one can use one of a plurality of methods, including measuring the frozen food mass, measuring the frozen food volume, monitoring a texture of a surface area of the frozen food, measuring a heat transferred to the frozen food and measuring a surface temperature of the frozen food.

In one embodiment, monitoring the state of the thawing includes calculating an injected heat value using an output temperature, the thawing temperature and a rate of displacement of the fluid in the thawing appliance, the output temperature being a temperature of the fluid measured at the outlet of the path.

It is possible to detect an occurrence of a phase-change plateau using the injected heat value, calculate a time Tₚ required to reach the plateau; and correlate the time Tₚ with a thawing duration. The thawing duration is then used to determine the time for the generation of the thawing completion state indicator.

In one embodiment, calculating an approximate surface temperature of the frozen food using the injected heat value will provide another way to monitor the state of the frozen food.

It is possible for the method to include a step of compensating for a heat transfer loss caused by the membrane.

In one embodiment, the membrane can be composed of adjacent walls of a plurality of bladders containing the fluid. If the fluid is to be circulated in the appliance, the bladders can include passageways to force the fluid to follow a thawing path during the displacing.

The thawing process can be triggered by different actions, such as the detection of an opening of the thawing appliance, the detection of an insertion of the frozen food in the thawing appliance, the detection of a closing of the thawing appliance, the receipt of a user input to trigger the thawing process.

Bringing the fluid close to a surface of the frozen food can be carried out by collapsing the membrane onto the frozen food by applied a vacuum between the frozen food and the membrane, modifying a pressure of an interior of the thawing appliance and/or by modifying a pressure of the fluid in the thawing appliance.

As will be readily understood, controlling the fluid at the conservation temperature includes controlling the fluid at at least one intermediary temperature between the thawing temperature and the conservation temperature.

User notifications can be outputted to notify the user about operation of the thawing appliance. The user notifications can be, for example, information about the state of the frozen food, information about a time remaining to reach the thawing completion state and information about the state of the thawing.

The embodiments described above are intended to be exemplary only.

1. A method for thawing frozen food provided in a thawing appliance, said thawing appliance having a membrane forming a barrier between said frozen food and a fluid, said membrane receiving said frozen food therewithin, said fluid at least partly surrounding said frozen food in use to transfer heat from said fluid to a corresponding surface area of said frozen food, said method including:
controlling said fluid at a thawing temperature;
monitoring a state of said thawing of said frozen food and generating a state indicator; and
controlling said fluid at a conservation temperature when said state indicator indicates a thawing completion state, said thawing temperature being greater than said conservation temperature, said conservation temperature being higher than 0° C.

2. The method as claimed in claim 1, further comprising displacing said fluid along a thawing path in said thawing appliance, said fluid being displaced from an inlet to an outlet of said thawing path.

3. The method as claimed in claim 1, wherein said monitoring said state of said frozen food includes at least one of measuring said frozen food mass, measuring said frozen food volume, monitoring a texture of a surface area of said frozen food, measuring a heat transferred to said frozen food and measuring a surface temperature of said frozen food.

4. The method as claimed in claim 2, wherein said monitoring said state of said thawing includes calculating an injected heat value using an output temperature, said thawing temperature and a rate of displacement of said fluid in said thawing appliance, said output temperature being a temperature of said fluid measured at said outlet of said path.

5. The method as claimed in claim 4, further comprising detecting an occurrence of a phase-change plateau using said injected heat value; calculating a time Tₚ required to reach said plateau; and correlating said time Tₚ with a thawing duration, wherein said generating said thawing completion state indicator being carried up after said thawing duration has elapsed.

6. The method as claimed in claim 4, further comprising calculating an approximate surface temperature of said frozen food using said injected heat value.

7. The method as claimed in claim 1, wherein said membrane is composed of adjacent walls of a plurality of bladders containing said fluid.

8. The method as claimed in claim 2, wherein said membrane is composed of adjacent walls of a plurality of bladders containing said fluid and wherein said bladders include passageways to force said fluid to follow said thawing path during said displacing.

9. The method as claimed in claim 1, further comprising receiving a thawing process trigger, said thawing process trigger being caused by at least one of detection of an opening of said thawing appliance, detection of an insertion of said frozen food in said thawing appliance, detection of a closing of said thawing appliance, receipt of a user input to trigger said thawing process.

10. The method as claimed in claim 1, wherein said thawing temperature is 12 degrees Celcius.

11. The method as claimed in claim 1, wherein said conservation temperature is 4 degrees Celcius.

12. The method as claimed in claim 1, wherein said food item is surrounded by a food containment bag.

13. The method as claimed in claim 1, further comprising bringing said fluid close to a surface of said frozen food by at least one of collapsing said membrane onto said frozen food by applied a vacuum between said frozen food and said membrane, modifying a pressure of an interior of said thawing appliance and modifying a pressure of said fluid in said thawing appliance.

14. The method as claimed in claim 1, further comprising outputting a user notification, said user notification including at least one of information about said state of said frozen food, information about a time remaining to reach said thawing completion state and information about said state of said thawing.

15. The method as claimed in claim 1, wherein said fluid is water.

16. The method as claimed in claim 1, wherein said controlling said fluid at said thawing temperature includes compensating for a heat transfer loss caused by said membrane.

17. The method as claimed in claim 1, wherein said thawing temperature is comprised between 8 and 20 degrees Celcius.

18. The method as claimed in claim 1, wherein said conservation temperature is comprised between 0 and 10 degrees Celcius.

19. The method as claimed in claim 1, wherein said controlling said fluid at said conservation temperature includes controlling said fluid at at least one intermediary temperature between said thawing temperature and said conservation temperature.
